(19) United States
(12) Patent Application Publication
(10) Pub. No.: US 2009/0153317 A1
(43) Pub. Date: Jun. 18, 2009

(54) SMART KEY SYSTEM USING LF ANTENNAS OF TPMS

(75) Inventor: Eun Hee Kim, Gyeonggi-do (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/276,887

(22) Filed: Nov. 24, 2008

(30) Foreign Application Priority Data
Dec. 12, 2007 (KR) 10-2007-0129288

(51) Int. Cl. B60C 23/00

(52) U.S. Cl. 340/447

(57) ABSTRACT

The present invention provides a smart key system using Low Frequency (LF) antennas of a Tire Pressure Monitoring System (TPMS), in which a Central Processing Unit (CPU) installed inside a vehicle control locking modules of respective doors to be opened or locked in response to an open/close signal from a smart key configured to transmit/receive a wireless signal unique to the vehicle. A plurality of antennas are installed on the vehicle for receiving a low frequency control signal transmitted from the smart key. One or more of the antennas are the LF antennas used for the TPMS of the vehicle.

### CROSS-REFERENCE TO RELATED APPLICATIONS

This application claims under 35 U.S.C. §119(a) priority to Korean Application No. 10-2007-0129288, filed on Dec. 12, 2007, the disclosure of which is incorporated herein by reference in its entirety.

### BACKGROUND

1. Technical Field

The present invention relates generally to a smart key system, and, more particularly, to a smart key system in which Low Frequency (LF) antennas of a Tire Pressure Monitoring System (TPMS) can be used for the smart key system.

2. Background Art

With the improvement in the standard of living, the popularization of privately owned cars has increased, and thus privately owned cars have established themselves as life necessities. Therefore, research into devices for preventing vehicles, including privately owned cars, from being stolen, and into various techniques for opening the doors of a vehicle and starting the engine of the vehicle has been steadily conducted. Examples include a keyless entry method and a keyless start method.

The keyless entry method refers to a method in which a driver opens or locks vehicle doors without operating a separate key or a remote controller. When a driver carries a key, the key and a digital authentication device transmit/receive data therebetween. If the data is verified, the locking modules of the doors are automatically operated.

In such a system, a smart key is used. The smart key internally includes a device for transmitting/receiving authentication information for a vehicle and a Radio Frequency (RF) signal, and a plurality of antennas are provided inside and outside a vehicle so as to communicate with the smart key.

In order to implement the smart key system, up to, for example, 10 antennas, each having low frequency characteristics (125 kHz or 134 kHz band), are used.

The antennas of the smart key system are used to detect a smart key outside a vehicle. Here, radio waves generated fall within a distance of 1 m from the vehicle, so that the detection of and communication with the smart key can be performed within this distance.

Meanwhile, antennas employing a low frequency method are used in a TPMS capable of measuring the tire pressure of a vehicle in real time and notifying a driver of it.

Each tire is provided with a pressure sensor for measuring internal pressure, and each pressure sensor is provided with an LF antenna (Initiator) for transmitting pressure information in a wireless signal form. The pressure sensor operates only when the engine of the vehicle is started.

FIG. 1 is a view showing the locations of respective antennas installed in a prior art smart key system and a TPMS. FIGS. 2 and 3 are block diagrams showing the respective configurations of the prior art smart key system and the TPMS.

As shown in FIG. 1, respective antennas 23 and 33 for the smart key system and TPMS are installed on predetermined portions of the side surface (e.g., door handles and wheel guides) of a vehicle.

The smart key system employs door handle antennas 23 installed inside the respective door handles of the vehicle and configured to monitor the side surfaces of the vehicle, indoor antennas 24 installed on the indoor ceiling or back seats of the vehicle and configured to monitor the inside of the vehicle, and a bumper antenna 25 installed inside a rear bumper and configured to monitor the rear of the vehicle.

Each of the antennas 23, 24, and 25 transmits a signal used to wake up a smart key 26, and allows the doors of the vehicle to be opened or locked using authentication information returned from the smart key.

Further, in the case of the TPMS, a pressure sensor 35, installed in each tire, measures the pressure of the tire, and then transmits the measured pressure to the LF antenna 33 using an LF transmitter 34, so that pressure information is transmitted to a Central Processing Unit (CPU) 31, thereby notifying the vehicle driver of the pressure information. For this purpose, the LF antenna 33 periodically or non-periodically transmits a signal used to wake up the corresponding pressure sensor 35.

However, although all the antennas 23, 24, and 25, used for the smart key system, and the LF antennas 33, used for the TPMS, use the same frequency and the configurations of the hardware thereof are the same, the antennas 23, 24, and 25 and the LF antennas 33 are separately installed for the two separate systems, thereby increasing manufacturing costs.

The above information disclosed in this the Background section is only for enhancement of understanding of the background of the invention and therefore it may contain information that does not form the prior art that is already known in this country to a person of ordinary skill in the art.

### SUMMARY

Accordingly, the present invention has been made keeping in mind the above problems occurring in the prior art, and an object of the present invention is to provide a smart key system in which the LF antennas of a TPMS are used instead of the door handle antennas of a smart key system, thereby reducing manufacturing costs.

In one aspect, a smart key system using the Low Frequency (LF) antennas of a Tire Pressure Monitoring System (TPMS), in which a Central Processing Unit (CPU), installed inside a vehicle, performs control such that locking modules of respective doors are opened or locked in response to an open/close signal from a smart key configured to transmit/receive a wireless signal unique to the vehicle, the smart key system including a plurality of antennas installed on the vehicle, and configured to receive a low frequency control signal transmitted from the smart key in a Radio Frequency (RF) signal form; and low frequency driver configured to separate a control signal for the locking modules from the RF signal input to the antennas, and apply the control signal to the CPU; wherein one or more of the antennas are the LF antennas used for the TPMS of the vehicle.

The antennas include internal antennas mounted inside the vehicle, and the LF antennas of the TPMS mounted on respective tire wheels.

The antennas transmit a wake-up signal to the smart key if a command to open/close the locking modules is detected in the ignition-off state of the vehicle; and the CPU performs control such that the locking modules are opened or closed if the smart key is authenticated.

The LF antennas of the TPMS apply to the CPU through a low frequency driver pressure information received from pressure sensors installed on respective tire wheels at corresponding locations in the ignition-on state of the vehicle.

The antennas include internal antennas mounted inside the vehicle, and the LF antennas of the TPMS mounted on respective tire wheels; and the low frequency driver includes a first LF driver for separating the control signal for the locking modules from the RF signal input to the antennas, and then apply the control signal to the CPU, and a second LF driver for applying to the CPU tire pressure information input to the LF antennas.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the locations of antennas separately installed in a smart key system and a TPMS according to the prior art;

FIGS. 2 and 3 are block diagrams showing the configurations of the smart key system and the TPMS according to the prior art;

FIG. 4 is a block diagram showing the configuration of a smart key system according to the present invention; and

FIG. 5 is a flowchart showing the flow of the operation of the smart key system according to the present invention.

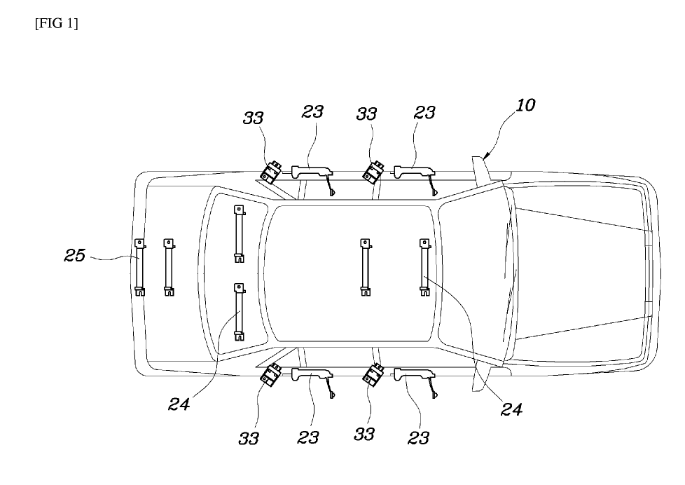

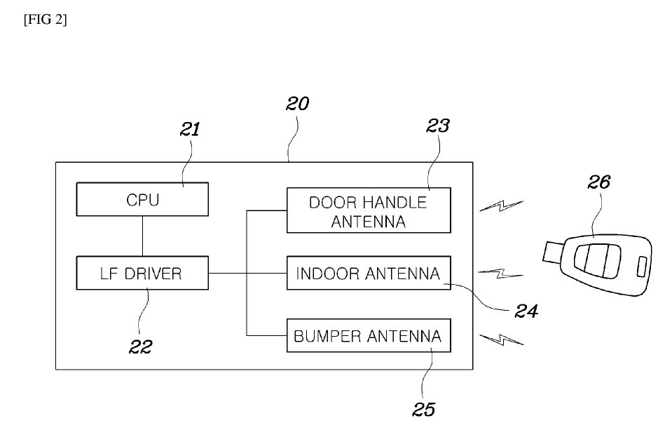

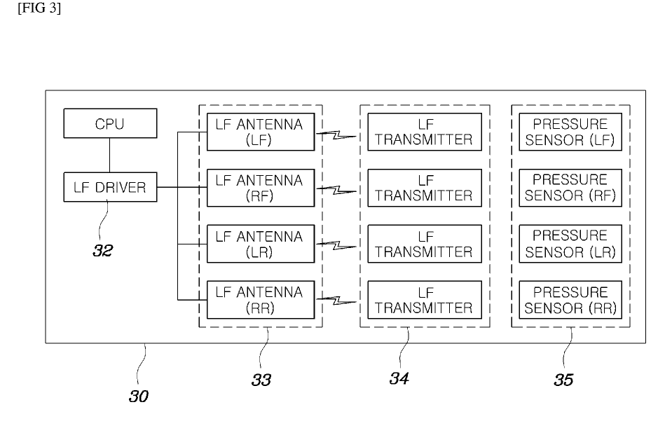

### DETAILED DESCRIPTION

Reference now should be made to the drawings, in which the same reference numerals are used throughout the different drawings to designate the same or similar components.

A smart key system using LF antennas of a TPMS (hereinafter referred to as ‘smart key system’) according to embodiments of the present invention will be described in detail with reference to the attached drawings below.

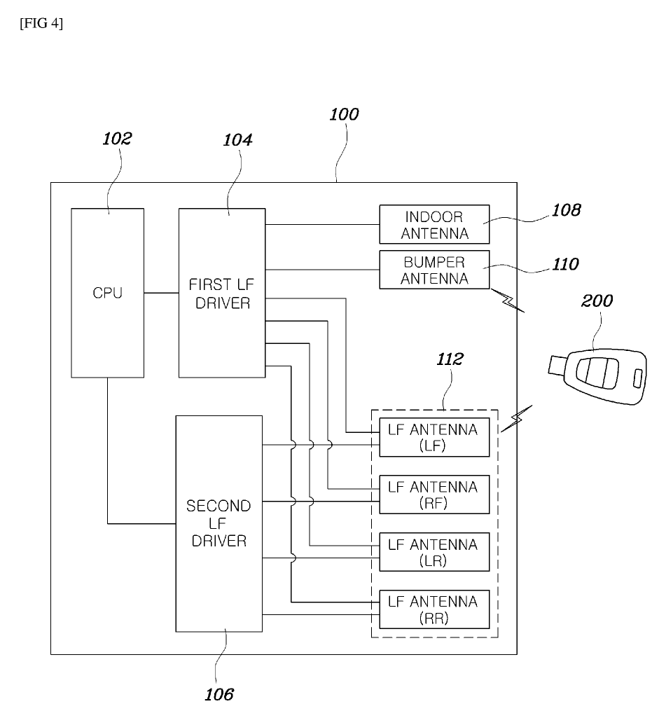

FIG. 4 is a block diagram showing the configuration of the smart key system according to an embodiment of the present invention.

As shown in FIG. 4, a smart key system 100 includes a CPU 102 for controlling the operation of locking a door and detecting tire pressure, and first and second LF drivers 104 and 106 for transmitting/receiving signals used to operate the respective systems thereof. Of course, the first and second LF drivers 104 and 106 may be implemented as an integrated low frequency driver.

In FIG. 4, the first LF driver 104 is used to operate the smart key system and the second LF driver 106 is used to operate the TPMS. The second LF driver 106 may be realized as a separate driver.

The first LF driver 104 is connected to LF antennas 112 and internal antennas such as an indoor antenna 108 and a bumper antenna 110.

As described above, the indoor antenna 108 is installed on the ceiling or each of back seats of a vehicle, and the bumper antenna 110 is installed inside a back bumper.

The second LF driver 106 is connected to the LF antennas 112. As shown in FIG. 4, for example, the LF antennas can be consisted of four antennas, LF, RF, LR, and RR. Although not shown in FIG. 4, the four LF antennas 112 are installed on four tire wheels, respectively, and are configured to communicate using four respective LF transmitters for transmitting pressure information applied from pressure sensors, installed on the corresponding tire wheels, and RF signals.

In particular, the LF antennas 112 are used for the highline of the TPMS, and are configured to detect a tire the pressure of which deviates from a predetermined level.

A driver can open a door or start an engine when he/she approaches a vehicle while possessing a smart key 200.

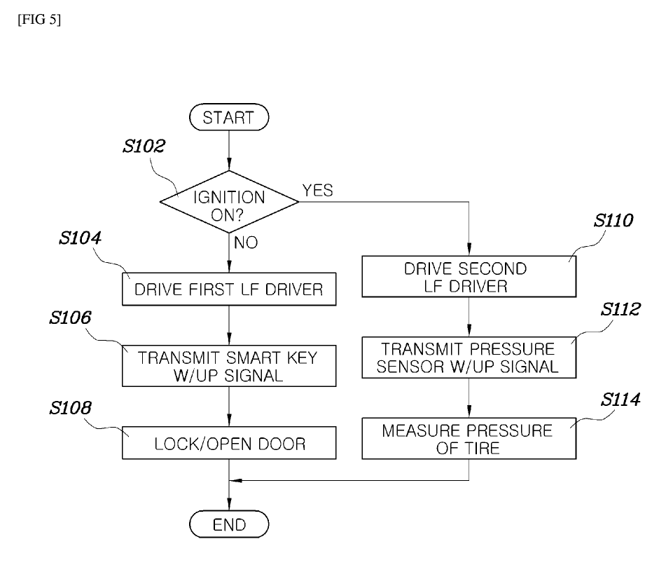

The operation of this system according to an embodiment will be described with reference to FIG. 5.

First, the smart key system 100 monitors the ignition-on state of the vehicle at step S102. The TPMS monitors variation in the pressure of each tire while a vehicle is traveling. Accordingly, the LF antennas 112 for the TPMS are required to be operated only in the ignition-on state. On the other hand, the antennas for the smart key are required in the ignition-off state. For this reason, the ignition-on state of the vehicle is monitored first.

If the vehicle is in the ignition-off state, the first LF driver 104 is driven to control the operation of locking doors at step S104.

When the first LF driver 104 is driven, each of the indoor antenna 108, the bumper antenna 110, and the LF antennas 112 transmits a smart key wake-up signal at step S106. That is, the LF antennas 112 of the TPMS substitute for the prior art door handle antennas 23.

When authentication information is input from the smart key 200 in response to the transmitted driving signals, the locking modules (not shown) of the respective doors are open or locked under the control of the CPU 102 at step S108.

On the other hand, if the vehicle is in the ignition-on state, the second LF driver 106 is driven to monitor the pressure of each tire at step S110.

When the second LF driver 106 is driven, each of the LF antennas 112 transmits a driving signal to each of the pressure sensors installed on the respective tires at step S112.

Further, since the pressure information, transmitted from the respective pressure sensors, are applied to the CPU 102 through the four LF antennas 112 and the second LF driver, the pressure of respective tires can be measured at step S114.

According to the above-described smart key systems, the number of antennas can be reduced, thereby reducing manufacturing costs and simplifying the process of mounting antennas.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A smart key system using Low Frequency (LF) antennas of a Tire Pressure Monitoring System (TPMS), in which a Central Processing Unit (CPU) installed inside a vehicle performs control such that locking modules of respective doors are opened or locked in response to an open/close signal from a smart key configured to transmit/receive a wireless signal unique to the vehicle, the smart key system comprising:
a plurality of antennas installed on the vehicle, and configured to receive a low frequency control signal transmitted from the smart key in a Radio Frequency (RF) signal form; and
a low frequency driver configured to separate a control signal for the locking modules from the RF signal input to the antennas, and apply the control signal to the CPU;
wherein one or more of the antennas are the LF antennas used for the TPMS of the vehicle.

2. The smart key system as set forth in claim 1, wherein the antennas comprise internal antennas mounted inside the vehicle, and the LF antennas of the TPMS mounted on respective tire wheels.

3. The smart key system as set forth in claim 1, wherein:
the antennas transmit a wake-up signal to the smart key if a command to open/close the locking modules is detected in an ignition-off state of the vehicle; and
the CPU performs control such that the locking modules are opened or closed if the smart key is authenticated.

4. The smart key system as set forth in claim 1, wherein the LF antennas of the TPMS apply to the CPU through a low frequency driver pressure information received from pressure sensors installed on respective tire wheels at corresponding locations in an ignition-on state of the vehicle.

5. The smart key system as set forth in claim 1, wherein:
the antennas comprise internal antennas mounted inside the vehicle, and the LF antennas of the TPMS mounted on respective tire wheels; and
the low frequency driver comprises a first LF driver for separating the control signal for the locking modules from the RF signal input to the antennas, and then apply the control signal to the CPU, and a second LF driver for applying to the CPU tire pressure information input to the LF antennas.
